(19) United States
(12) Patent Application Publication
(10) Pub. No.: US 2002/0034561 A1
(43) Pub. Date: Mar. 21, 2002

(54) Method of supporting a heated molded pattern

(75) Inventor: Paul N. Latulippe JR., Chino Valley, AZ (US)

Correspondence Address: PENNIE AND EDMONDS, 1155 AVENUE OF THE AMERICAS, NEW YORK, NY, 100362711

(73) Assignee: STURM, RUGER & COMPANY, INC.

(21) Appl. No.: 09/892,038

(22) Filed: Jun. 26, 2001

Related U.S. Application Data
(62) Division of application No. 09/217,702, filed on Dec. 21, 1998.

(51) Int. Cl. B29C 45/03

(52) U.S. Cl. 425/542; 425/572

(57) ABSTRACT

An improvement setter and method of operation for maintaining and reconfigurating the shape of a malleable pattern used in molding of parts. The setter includes an arrangement for arranging the pattern against the setter using vacuum.

### BACKGROUND OF THE INVENTION

Wax and other malleable pattern materials such as plastics are produced for use in the production of investment castings. Such patterns are generally produced by injection molding and other molding techniques. Such wax patterns are initially created by injection of liquid wax into aluminum or epoxy molds maintained at a temperature below that of the melting temperature of the wax. After injection the wax is held within the mold cavity for a suitable dwell time to allow for solidification, and thereafter it is removed from the mold. Because wax is a poor thermal conductor, the dwell time for complete cool down to room temperature is usually uneconomic and excessive from a production standpoint. Therefore, the solidified wax patterns are generally removed from such molds while the wax is still warm, and the wax pattern then cools down to room temperature outside of the mold cavity. Removal of warm wax from the mold cavity and such cool down to room temperature outside of the mold cavity subjects the wax to warping, sagging, or cool down, and other forces.

To minimize such distortion during cool down of warm wax to room temperature, metal setters have been used. Metal setters are positioned in engagement with the patterns to maintain the pattern shape during cooling. Metal setters are positioned in engagement with the patterns to maintain the pattern shape during cooling. Prior setters have used the weight of the pattern with or without additional force or weight applied to the pattern to urge the pattern against the setter. However, prior setters have not operated to accomplish a high degree of dimensional accuracy in pattern formation. If weight is to be applied to a wax pattern to cause it to conform to the surface of a setter, the shape of the wax pattern may not, in fact, lend itself to applying such weight to the surface of the wax.

The accuracy of the dimensional shape of an investment casting is dependent on the dimensional accuracy of the pattern from which the casting originates. A pattern which is distorted during cooling outside of its mold will produce a casting which deviates from specified production dimensions. Such deviation may cause the object to be dimensionally unacceptable. There has been a need for a wax pattern that would consistently and economically improve dimensional accuracy in investment cast object.

### SUMMARY OF THE INVENTION

Broadly, the present invention is a setter apparatus for engaging patterns or portions thereof during their cooling. The apparatus includes an array of setters each of which has a support body having a support surface, an evacuation chamber and a chamber pressure reducer for causing a heated pattern to be brought into engagement with such support surface. The pressure between the pattern and support surface is reduced below atmosphere pressure causing atmospheric pressure to urge the pattern and surface toward one another. The pattern and support surface are held during cooling until the pattern has reached a temperature such that the pattern is no longer distorted by gravity, temperature differentials or other forces. The invention also includes the method of operating the apparatus.

The invention is particularly useful for the cooling of patterns used in molding precisely dimensioned objects such as a golf club head. Wood-type golf club heads have convex areas of the club head ball-striking face. These convex curvatures are sometimes referred to as the “roll and bulge”.

### BRIEF DESCRIPTION OF THE DRAWINGS

FIG. 1 is a plan view of a golf club head made in accordance with the present invention;

FIG. 2 is a front elevational view of the head of FIG. 1 including the ball-striking surface;

FIG. 3 is a plan view of the head showing the face roll;

FIG. 4 is a front elevational view of the head showing the face bulge;

FIG. 5 is a front elevational view of a pattern used in the practice of the invention;

FIG. 6 is an array of pattern setters; and

FIG. 7 is a sectional view taken along line 7-7 of FIG. 6.

### DESCRIPTION OF THE PREFERRED EMBODIMENT

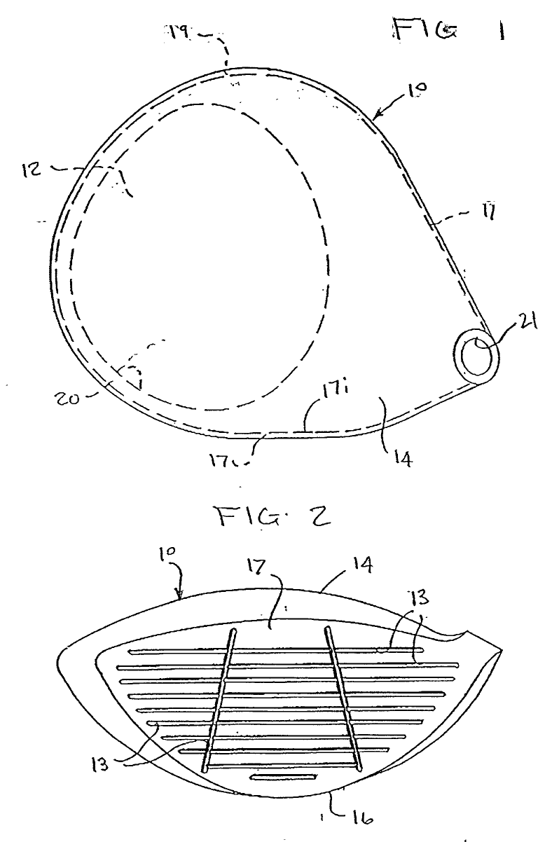

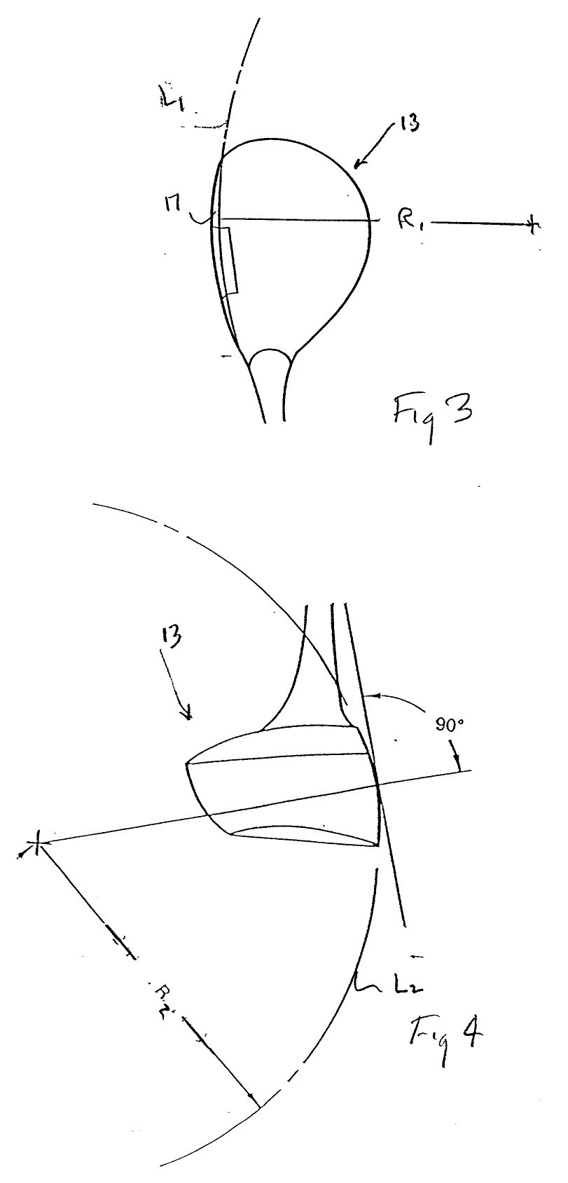

In FIGS. 1 and 2, golf club head part 10 includes a thin wall 11 and hollow interior 12. Thin wall 11 includes top wall portion 14, bottom wall portion 16, curved face wall portion 17 and rear wall portion 19. Wall portion 17 has interior surface 17i (FIG. 1). Opening 20 receives the sole plate (not shown) which sole plate is a separately fabricated part of the golf club head. Hosel opening 21 receives the club shaft or hosel (not shown).

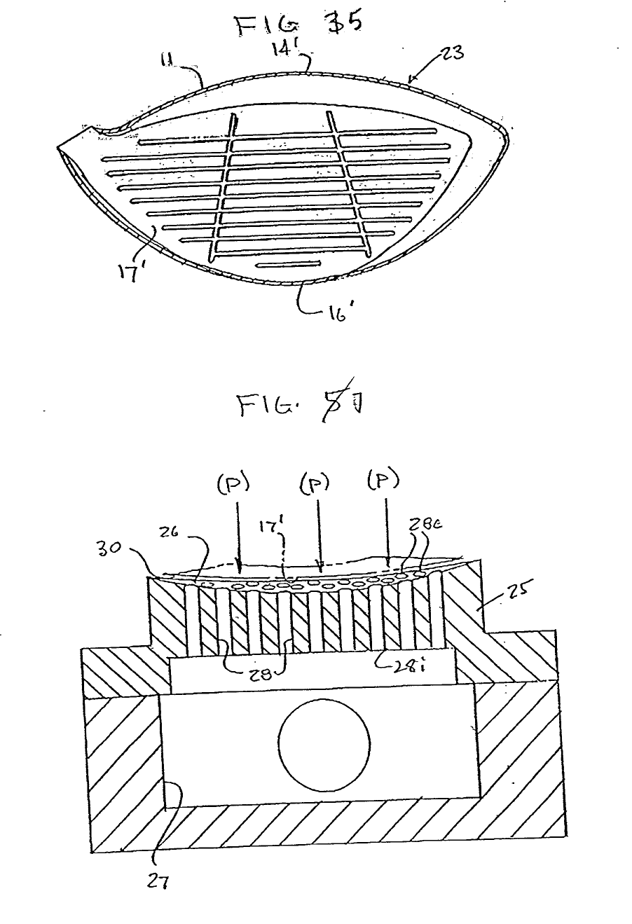

The face curvation of wall portion 17 incorporated in a finished golf club 13 is further shown in FIGS. 3 and 4. Curved face wall portion 17 has several characteristics which are horizontal face bulge and vertical face roll. Horizontal face bulge is defined by one or more curved lines L₁ defined by radius R₁. Curved line L₁ is measured from the heel to the toe in a horizontal plane along face portion 17 (see FIG. 3). Face bulge is usually the same at any point vertically up or down face portion 17. The other club head face curvature is vertical face roll defined by curved line L₂ inscribed by radius R₂ measured from the top to the bottom of the face in a vertical plane (see FIG. 4). Vertical face roll is usually the same at any point along the face from the heel to the toe. Horizontal face bulge functions to correct or compensate for the effect of the clubhead's center of gravity which compensates for unwanted hooking or slicing due to off-center hits. Vertical face roll varies the height of the trajectory of the ball depending on the vertical ball-impact location. The reason face roll is part of today's club design is that it is a tradition in club head face design.

Pattern 23 is dimensionally similar in size and shape as head portion 10 and is used to create ceramic shell molds for investment casting of metal golf club head part 10. During mold formation pattern 23 is produced by injection molding of liquid wax pattern material into a mold cavity defined by the shape and size of pattern 23. Thereafter, the wax pattern material is allowed to solidify within the mold, the segmented mold is opened, and pattern 23 removed from the mold. Pattern 23 has a thin wall 11′ including wall portions 14′, 16′ and 17′ similar to golf club head part 10. Pattern 23, made preferably of wax, is formed in an injection mold. Because of the size of pattern 23 and the thinness of its wall 11′, generally between 0.80″ and 0.150″ and its material and its temperature upon removal from the mold, pattern 23 is unstable at the time of removal. The pattern temperature at removal is in the range of 80° F. and 120° F. Wax patterns having thick sections may, at the time of removal from the mold, have sub-surface temperatures of about 140° F. due to the poor thermal conductivity of wax pattern material.

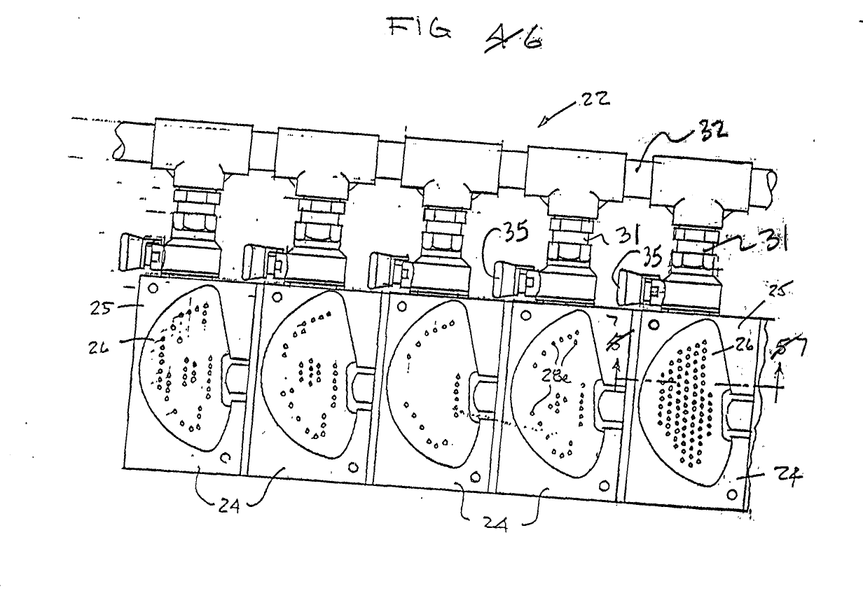

With respect to FIGS. 6 and 7, in order to maintain and correct the pattern shape during cooling, patterns are placed against an array 22 of setters 24. Each setter 24 has a solid and unyielding support wall 25 with a support wall surface 26 substantially the same size of wall portion 17 and of complementary shape to pattern face wall portion 17′. Each setter 24 has a chamber 27 with air evacuation passageways 28 connecting wall 25 and chamber 27. The exterior ends of passage 28 are holes 28e and the interior ends are holes 28e lying in the setter surface 26. Chambers 27 function as an evacuation chamber, to cause air to flow through passageways 28. Evacuation branch conduits 31 serve each chamber 27. Branch conduits 31 are connected to evacuation line 32 through valves 35. A vacuum of 5-30 inches of mercury is preferably drawn in supply line 32 and chambers 27 when valves 35 are opened.

The sizes of holes 28e are small relative to the strength of the material of pattern 23. The hole size is such that pattern 23 is not deformed into passages 28 and therefore no indentation or other marks are formed in pattern 23 during the air evacuation process. Alternatively, setter support walls 25 may be porous allowing air to flow through walls 25 to create the required vacuum. Walls 25 must have sufficient thickness and rigidity to maintain their shape even under the high pressures created by evacuation of chambers 27.

The number, spacing, size and shape of passageway exterior holes 28e are such that with the pressure reduction urges wall surface 17 against setter surface 26 causing wall surface 17′ to assume the correct shape without thereafter any distortion of such surface during cooling. Air is drawn through passageways 28 to create a selectively reduced pressure in chamber 27 and in the space 30 between the face wall portion 17′ and support wall 26. When the pressure is lowered in chamber 27 and in space 30 the surfaces 17′ and 26 are brought together. Upon opening of the valve 35 serving a particular setter 24, 25 malleable pattern face wall portion 17 is drawn into space 30 thus reducing the volume of space 30 as wall portion 17′ conforms to the shape of metal support surface 26. Atmospheric press (P) exerts a uniform force urging face wall portion 17′ against support wall 26. Since patterns 23 have hollows 12 and openings 20, walls 17′ have an interior surface 17i′ (not shown) against which atmospheric pressure operates when a vacuum is drawn.

Reduced pressure is maintained in chamber 27 until pattern 23 and its face wall 17′ have cooled to a state of solidification in which the likelihood of distortion no longer exists.

Setters may be used to assist in correcting and stabilizing other club head surfaces during cooling; however, it is known that in club head manufacture including woods, irons and putters, that accuracy in fabrication of the profile of the ball-striking face is always of major importance along with other head surfaces.

Other patterns for molding golf club head parts such as sole plates and crown plates may be processed by this invention. In addition, patterns for manufacturing objects and parts, where improved compliance with specifications of surface profiles is desired, may be treated using the present invention, such as, for example, aircraft air foil blades and vanes.

In an alternative embodiment, setters 24 are cooled below ambient temperature prior to receiving the malleable patterns. Cooled setters 24 accelerate pattern cooling time. This invention contemplates the cooling of patterns to a state of solidification for storage or other reason in which state the use of setters is not effective and thereafter raising the pattern temperature to a level where setter treatment is useful.

In the operation of the method of the present invention, pattern 23 having a high temperature is removed from its mold and transported to a setter 24 which is normally at room temperature. During such transport, pattern 23 is malleable and subject to change in shape, size and other distortions. Pattern 23 with its surface 17′ is placed against setter surface 26 leaving a very small space 30 between the surfaces. Since setter 24 and its surface 26 are at room temperature, pattern 23 is caused to cool when it is placed on setter 24.

The reduction of pressure in space 30, passages 28 and setter chamber 27 causes surfaces 17′ and 26 to come together reducing or eliminating space 30. When such surfaces are brought together (and thereafter continued to be urged together during cooling), pattern surface 17′ is reconfigured to the extent it was distorted during the removal from its mold and its transport to the setter. To the extent no distortion of pattern 23 or its surface 17′ or portions thereafter has occurred prior to setter engagement, setter 24 functions to maintain the shape and size of pattern surface 17′.

I claim:

1. An apparatus for engaging, supporting and reconfiguring a malleable pattern during its cooling which pattern has a surface of specified size and shape comprising:
a pattern support member having a support surface of substantially the same size and with a shape complementary to said pattern surface: said pattern support member capable of supporting a pattern at temperatures at which the pattern is malleable;
the pattern support member support surface positioned adjacent the pattern;
support the pattern;
pressure reducing means for reducing the pressure adjacent the pattern member
whereby the surface of the malleable pattern is urged against the pattern member support surface.

2. The apparatus of claim 1 in which the malleable pattern is a pattern for use in molding a golf club head part.

3. The apparatus of claim 1 in which the pattern support member is cooled below ambient temperature prior to the pattern being positioned against such pattern support member.

4. The apparatus of claim 1 in which the pattern support member includes a chamber adjacent the member support surface, in which the support surface has passageways there through and in which pressure reducing means reduces the pressure in the chamber to cause said surfaces to engage one another.

5. The apparatus of claim 4 in which the passageway has exit openings which are adjacent the pattern surface and in which the openings are spaced and sized to prevent pattern deformation during pressure reduction.

6. The apparatus of claim 1 in which the pattern support member surface is shaped to produce the desired pattern surface when the malleable pattern is urged against such pattern support member surface.

7. A method of supporting a malleable pattern during a period of its cooling comprising:
1) providing a pattern support member;
2) positioning a pattern having a surface and having a temperature at substantially above ambient temperature adjacent such support member;
3) causing the pattern surface to be urged against such support member employing gaseous pressure during the cooling period
whereby the pattern surface is maintained and reconfigured during such cooling.

8. The method of claim 7 in which the pattern is a pattern for a golf club.

9. The method of claim 7 in which the pattern has an exterior surface of particular curvature and the pattern support member has a second exterior surface complementary to said pattern exterior surface curvature so that the urging of the exterior surfaces together during temperature reduction assists in maintaining the particular profile of the pattern surface.

10. The method of claim 7 in which the pattern support member is cooled prior to positioning a pattern adjacent the pattern support member.
